(19) United States
(12) Patent Application Publication
(10) Pub. No.: US 2014/0238785 A1
(43) Pub. Date: Aug. 28, 2014

(54) DOUBLE ACTING SPOOL-SHAPED FLUID CYLINDER LOCK

(71) Applicant: SUSPA GMBH, Altdorf (DE)

(72) Inventors: Glen Robert Wilkinson, Paw Paw, MI (US); Kevin Thomas Braat, Portage, MI (US)

(73) Assignee: Suspa GmbH, Altdorf (DE)

(21) Appl. No.: 13/774,494

(22) Filed: Feb. 22, 2013

(51) Int. Cl. F16B 7/14

(52) U.S. Cl. CPC F16B 7/1418
USPC 188/67

(57) ABSTRACT

A brake for a rod includes a spool-shaped lock having conical opposed open ends communicating with a cylindrical opening. Positioned within the cylindrical opening is an inwardly projecting shoe for engaging the outer cylindrical surface of a rod to be controlled. A pair of conical members are positioned in association with the mating conical ends of the spool and are housed in a cage for holding the components in an assembled position when a rod to be controlled is inserted through the conical members and the spool-shaped locking member. The conical members are biased to a locking position and a control rod is coupled to the spool and actuated by a safety release mechanism to allow the rod to move. In a preferred embodiment, a gas spring with the present locking mechanism is coupled between two telescopic tubes defining one or more adjustable legs for a table or chair.

### BACKGROUND OF THE INVENTION

The present invention relates to a double acting lock for fluid cylinders.

Fluid cylinders used for raising and lowering adjustable tables, such as gas springs, are controlled by a variety of means to allow height adjustment without excessive sudden movement. Several designs exist for the control of gas springs typically used in table and chair height adjustments. Use of such gas springs is commonplace in the furniture industry in which chairs, tables, and other items are desired to be easily adjustable. Typically, the gas spring force is selected to counterbalance a normal weight load expected on a chair or table, and the stroke of the gas spring is selected for the desired amount of movement. To control telescopic support tubes in which gas springs are employed, mechanical locking mechanisms have been employed as well as controlling the flow of fluid on either side of the piston of a gas spring. Some of the mechanisms required for locking an adjustable table in place involve relatively complicated mechanisms which are both expensive and somewhat prone to failure.

There exists a need, therefore, for a relatively robust system which minimizes the number of components, reducing the cost and yet providing positive, reliable locking of an extendable rod of a gas spring in selected extended or retracted directions.

### SUMMARY OF THE INVENTION

A brake for a rod has a cylindrical member with a central opening for receiving a rod therethrough. The cylindrical member also has opposed open conical ends communicating with the central opening. A pair of conical members, each having a central aperture and conical outer surfaces, are positioned in opposed relationship with the conical ends of the cylindrical member. The axis of the central aperture and the axis of the conical outer surfaces of the conical members are offset from one another. A cage is provided for holding the conical members and the cylindrical member in an assembled position, such that a rod can be inserted through the conical members and the cylindrical member. A bias structure extends between the cage and the conical members to urge the conical members into engagement with the cylindrical member, such that at least the cylindrical member lockably engages a rod extending therethrough. A control rod is coupled to the cylindrical member and actuated by a safety release mechanism to allow the rod to move.

These and other features, objects and advantages of the present invention will become apparent upon reading the following description thereof together with reference to the accompanying drawings.

### BRIEF DESCRIPTION OF THE DRAWINGS

FIG. 1 is a perspective view of two adjustable tables incorporating the system of the present invention;

FIG. 2 is a side elevational view of the telescopic leg of the table support shown in FIG. 1,

FIG. 3 is an enlarged fragmentary perspective partly cutaway view of the leg showing the locking mechanism of the present invention;

FIG. 4 is a fragmentary perspective view of the locking mechanism of the present invention showing its relationship with a gas spring and polymeric bearing employed with the telescopic tubes of the leg shown in FIG. 3;

FIG. 5 is a fragmentary perspective view of the structure shown in FIG. 4 with the polymeric bearing deleted;

FIG. 6 is a front elevational view of the locking mechanism of the present invention;

FIG. 7 is a partial vertical cross-sectional view of the structure shown in FIG. 6;

FIG. 8 is a cross-sectional view of the structure shown in FIG. 6, taken along section line VIII-VIII;

FIG. 9 is a cross-sectional view of the structure shown in FIG. 6, taken along section line IX-IX; and

FIG. 10 is a partial cross-sectional view of the brake mechanism of the present invention shown in FIG. 7, taken along section lines X-X and illustrating the offset between the axis of the conical members and the spool.

### DETAILED DESCRIPTION OF THE PREFERRED EMBODIMENT

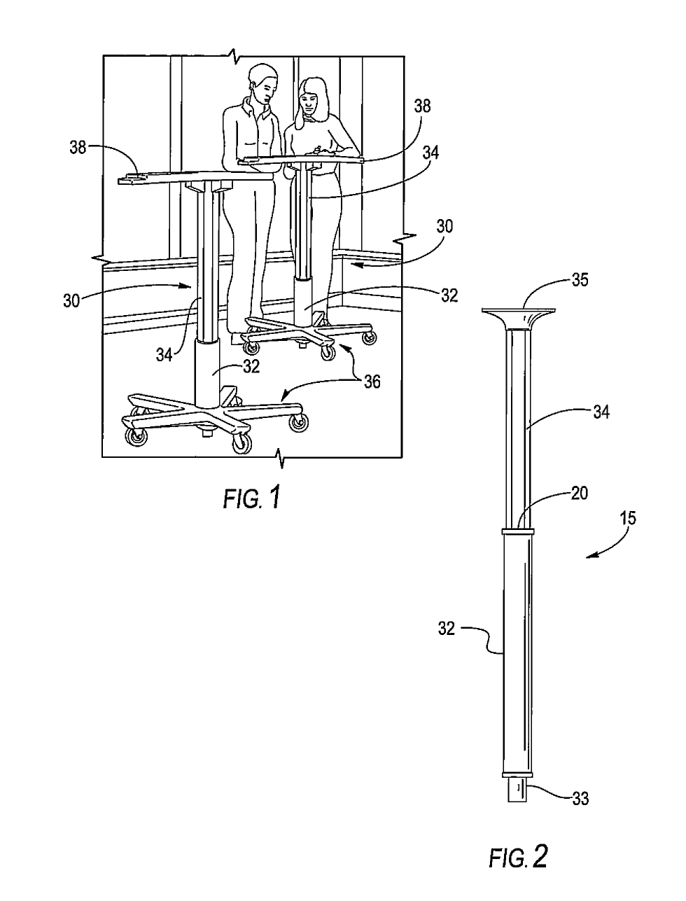

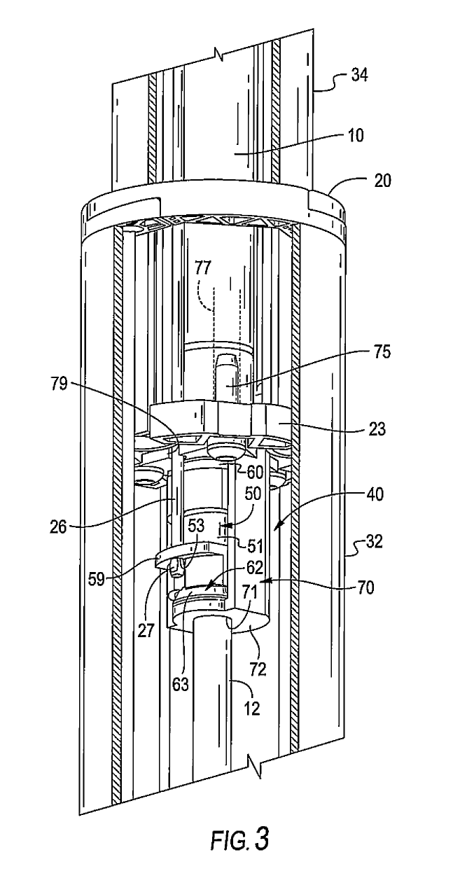

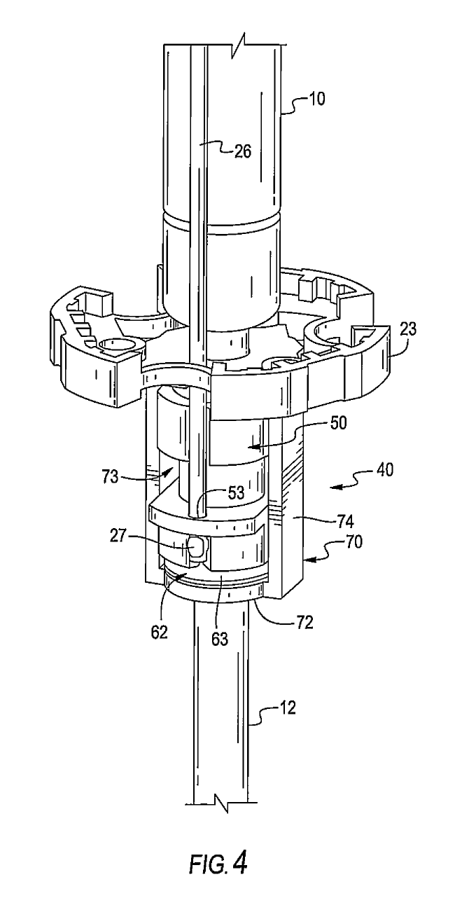

FIG. 1 shows adjustable tables 30 which include a height adjustment assembly including telescopic tubes 32 and 34 (FIG. 2) extending between a floor support 36 and a table surface 38. FIG. 2 shows one of the table legs 15 with a support flange 35 at the upper end of telescopic tube 34 and a fitting 33 which extends into a socket in the floor support 36 of FIG. 1. The telescopic tube 34 slideably extends within outer tube 32 with polymeric bearings 20 (FIGS. 2-3) and 23 (FIGS. 3-4) providing smoothly guided movement between the tubes 32, 34. These bearings and the general construction of the leg 15 are disclosed in U.S. patent application Ser. No. 61/758,997 filed on Jan. 31, 2013, entitled SELF-ALIGNING AXIAL BEARING, the disclosure of which is incorporated herein by reference. Within the telescopic tubes, there is a fluid cylinder, such as gas spring 10 shown in FIGS. 3-7, which controls a cylinder rod 12 to raise and lower the extruded inner table support tube 34. For such purpose, the opposite ends of spring 10 and its extendable rod 12 are conventionally coupled to the tubes 32, 34, such that extension of rod 12 causes the overall length of the tubes to extend. Fixedly coupled to the lower end of extruded tube 34 is the locking mechanism 40 incorporating the present invention and a safety release coupled to release rod 26 as described in U.S. patent application Ser. No. (Atty. Docket SUS001 P344), entitled SAFETY RELEASE, filed on the even herewith, the disclosure of which is incorporated herein by reference. The outer tube 32 is mounted to support member 33, in turn, coupled to the floor support 36. The orientation of the telescopic tubes can be reversed depending upon a particular application.

Referring now to FIGS. 3-7, there is shown the locking mechanism 40 of the present invention, which comprises three major components. It includes a spool-shaped brake member 50, a pair of conical clamping members 60, 62, and a support cage 70 holding the locking mechanism 40 together and in place at the lower end of the extendable tube 34.

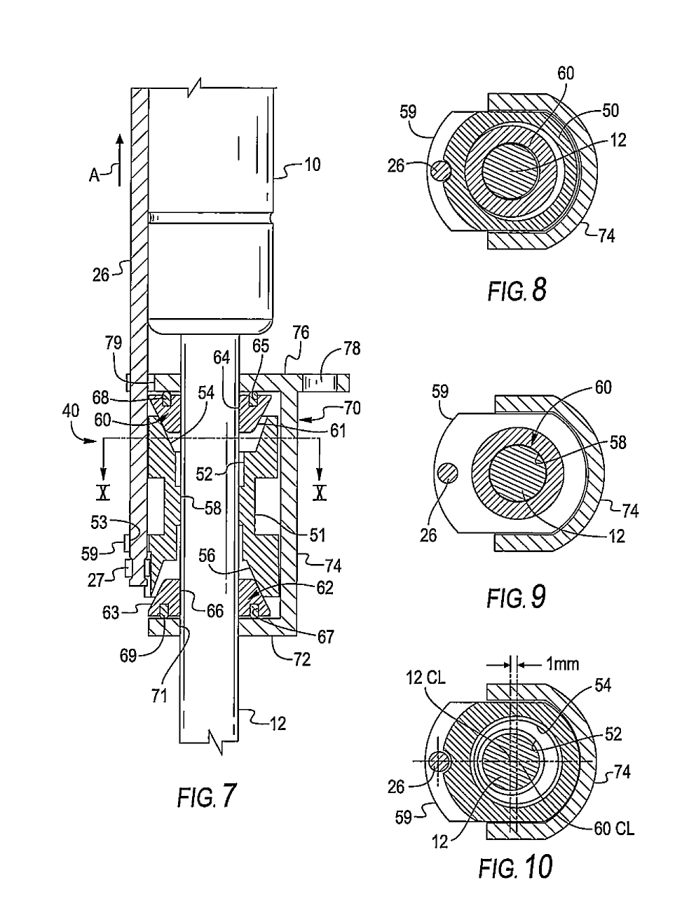

The spool-shaped brake 50 has a central aperture 52 (FIG. 7) which surrounds the extendable rod 12. The spool-shaped brake 50 includes conical recesses 54 and 56 at opposite ends and includes an integral inwardly projecting cylindrical shoe 58 in close engagement with the outer diameter of rod 12. The cylindrical shoe 58 is smaller in diameter than the larger central aperture 52 above and below shoe 58, which apertures 52 do not contact rod 12.

The second components of locking mechanism 40 constitute an upper conical clamping member 60 and a lower conical clamping member 62 having conical side walls 61 and 63, respectively, that conform to the taper of conical recesses 54, 56 of brake member 50. The conical clamping members 60, 62 include annular recesses 65, 67 at their outer ends which receive elastomeric rings 68, 69, respectively. Ring 68 engages the lower surface 81 of plate 76, while ring 69 engages the upper surface 83 of floor 72 of cage 70. The elastomeric rings are made of a synthetic rubber compound, such as Viton® and serve as bias means urging the conical members 60, 62 into engagement with brake member 50 for locking the position of rod 12 as described below. Brake member 50 includes an annular recess 51 on a side opposite cylindrical shoe 58 to reduce material used and, therefore, the cost of the brake member 50. Brake member 50 also includes an extension tab 59, which has an aperture 53 formed therein for guidably receiving release rod 26.

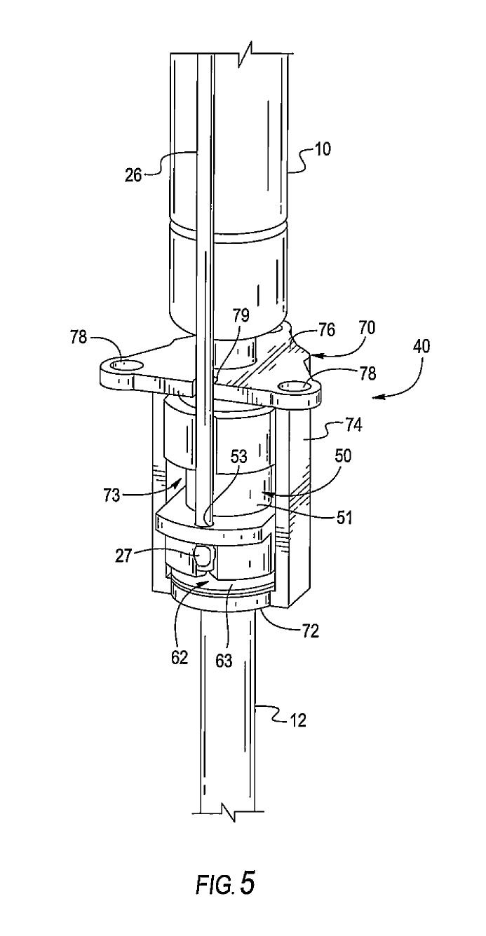

The assembly comprising brake member 50 and conical members 60, 62 is enclosed in a cage 70, which includes a lower cylindrical floor 72 with an aperture 71 (FIG. 7) through which rod 12 extends. Extending upwardly from floor 72 is a semi-cylindrical wall 74 having a side opening 73 for the assembly of spool brake member 50 and clamping members 60, 62 within the cage 70. Wall 74 extends upwardly to an integral upper generally triangular mounting plate 76 having apertures 78 in the outwardly projecting corners for receiving mounting bolts 75 (FIG. 3) which extend through the polymeric bushing 23 and into a threaded extrusion 77 (shown schematically in FIG. 3) in the inner extendable tube 34. This secures the cage 70 and locking assembly 40 to the lower end of extendable member 34. The upper plate 76 includes a notch 79 (FIG. 5) allowing the release rod 26 to extend by the plate and into engagement with extension tab 59 of the brake member 50. The end of the release rod, as seen in FIG. 5, includes a spring clip or other outwardly extending member 27 for coupling the lower end of release rod 26 to the brake member 50.

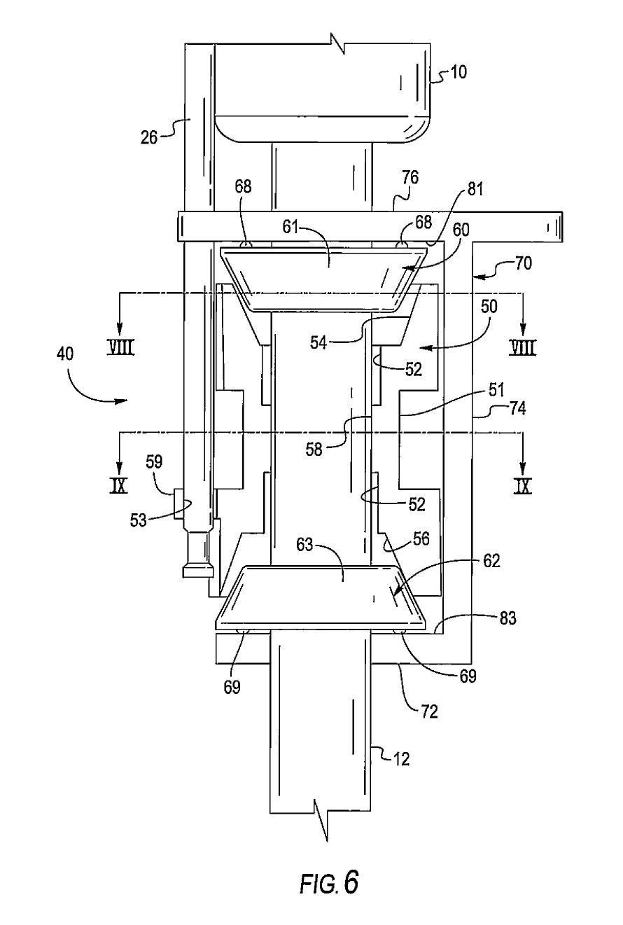

Referring now to FIGS. 6-10 and initially to FIG. 10, the center line or longitudinal axis of the rod 12 is identified in FIG. 10 as “12 CL.” The center line of each of the conical clamping members 60, 62 is identified in FIG. 10 as 60 CL and is offset from the centerline of rod 12 by about 1 mm, as shown in FIG. 10. 62 is offset in the other direction. This offset, together with the forces applied to conical clamping members 60, 62 by the elastomeric members 68, 69 cants the brake member 50 at a slight angle, such that the areas at the top and bottom edges of shoe 58 engage rod 12 as do the inner circular diameters of the apertures 64, 66 in the conical sections 60, 62, respectively. This results in the desired braking action as the diameter of rod 12 is approximately 0.1 mm smaller than the opening diameter of shoe 58 with about a 0.4% tolerance.

The spacing between floor 72 and upper plate 76 is such that, when in a balanced condition, the release lever 26 is at rest and elastomeric members are in a locking position, as illustrated in FIG. 7). When it is desired to raise the table, i.e., extend rod 12 from gas spring 10, rod 26 is raised in the direction indicated by arrow A in FIG. 7. This lifts the cage 70, allowing member 60 to release its binding force on the brake member 50 and rod 12. This, in turn, allows the rod to extend, assuming the predetermined load in connection with the safety release associated with rod 26 is not exceeded. Similarly, when it is desired to contract rod 12 to lower a table or chair, rod 26 is again raised in the direction indicated by arrow A, and the user pushes down on the table surface causing the inner tube 34 to push the cage 70 downwardly, releasing the locking engagement between the lower conical clamp 62 and its relationship with brake member 50, such that the table surface or chair height can be lowered. This again assumes that the weight limit does not exceed that of the safety release associated with control rod 26.

It will become apparent to those skilled in the art that various modifications to the preferred embodiment of the invention as described herein can be made without departing from the spirit or scope of the invention as defined by the appended claims.

The invention claimed is:

1. A brake for a rod comprising:
a cylindrical member having a central opening for receiving a rod therethrough, said cylindrical member having opposed open conical ends communicating with said central opening;
a pair of conical members each having a central aperture and conical outer surfaces positioned in opposed relationship with said conical ends of said cylindrical member, wherein the axis of said central aperture and the axis of said conical outer surfaces are offset from one another;
a cage for holding said conical members and said cylindrical member in an assembled position such that a rod can be inserted through said conical members and said cylindrical member; and
bias structure extending between said cage and said conical members to urge said conical members into engagement with said cylindrical member such that at least said cylindrical member lockably engages a rod extending therethrough.

2. The brake as defined in claim 1 and further including a release rod coupled to said cylindrical member to release the locking engagement with a rod.

3. The brake as defined in claim 1 wherein said cylindrical member is spool-shaped.

4. The brake as defined in claim 3 wherein said central opening of said cylindrical member has a center area with a smaller diameter defining a cylindrical shoe.

5. The brake as defined in claim 4 wherein said conical members have a flat surface facing said cage.

6. The brake as defined in claim 5 wherein said flat surface includes a recess.

7. The brake as defined in claim 6 wherein said bias structure comprises an elastomeric member seated within said recess and engaging said cage for urging said conical members toward said cylindrical member.

8. The brake as defined in claim 7 wherein said recess and said elastomeric member are circular.

9. The brake as defined in claim 8 wherein said cage includes a floor engaging one of said conical members, a wall extending from said floor, and a plate extending from said wall to engage the other of said conical members.

10. The brake as defined in claim 9 wherein said wall includes a side opening to allow said cylindrical member and said conical members to be positioned within said cage between said floor and plate.

11. The brake as defined in claim 10 and further including a rod of a gas spring extending through said central apertures of said conical members and through said central opening of said cylindrical member.

12. The brake as defined in claim 1 wherein said offset is about 1 mm.

13. A brake for the rod of a gas spring comprising:
a gas spring having an extendable and retractable rod;
a spool-shaped member having a central opening for receiving said rod therethrough, said cylindrical member having opposed open conical ends communicating with said central opening;
a pair of conical members each having a central aperture and conical outer surfaces positioned in opposed relationship with said conical ends of said cylindrical member, wherein the axis of said central aperture and the axis of said conical outer surfaces are offset from one another;
a support having spaced-apart ends with apertures for holding said conical members and said spool-shaped member in an assembled position such that said rod can be inserted through said conical members, said cylindrical member, and said support; and
bias structure extending between said ends and said conical members to urge at least one of said conical members and said spool-shaped member into engagement with said rod for lockably engaging said rod extending therethrough.

14. The brake as defined in claim 13 wherein said central opening of said spool-shaped member has a center area with a smaller diameter defining a cylindrical shoe.

15. The brake as defined in claim 14 wherein said conical members have a flat surface facing said ends of said support.

16. The brake as defined in claim 15 wherein said flat surface includes a recess.

17. The brake as defined in claim 16 wherein said bias structure comprises an elastomeric member seated within said recess and engaging said ends of said support for urging said conical members toward said cylindrical member.

18. The brake as defined in claim 17 wherein said recess and said elastomeric member are circular.

19. The brake as defined in claim 18 wherein said support includes a side opening to allow said spool-shaped member and said conical members to be positioned within said support between said ends.

20. The brake as defined in claim 13 and further including a release rod coupled to said spool-shaped member to release the locking engagement with a rod.

21. A brake for a rod comprising:
a cylindrical member having a central opening with a centered diameter reduced brake section for receiving a rod therethrough, said cylindrical member having opposed open conical ends communicating with said central opening;
a pair of conical members each having a central aperture and conical outer surfaces positioned in opposed relationship with said conical ends of said cylindrical member, wherein the axis of said central aperture and the axis of said conical outer surfaces are offset from one another by about 1 mm;
a generally U-shaped cage for holding said conical members and said cylindrical member in an assembled position such that a rod can be inserted through said conical members and said cylindrical member;
an elastomeric spring extending between ends of said cage and said conical members to urge said conical members into engagement with said cylindrical member such that said shoe of said cylindrical member lockably engages a rod extending therethrough; and
a release member coupled to said cylindrical member for axially moving said cylindrical member to disengage said rod.

22. The brake as defined in claim 20 wherein said conical members have a flat surface facing said cage and wherein said flat surface includes a recess for receiving said elastomeric spring.
